(19) United States
(12) Patent Application Publication
(10) Pub. No.: US 2013/0297162 A1
(43) Pub. Date: Nov. 7, 2013

(54) DYNAMIC SHIFT SCHEDULING IN A HYBRID VEHICLE HAVING A STEP RATIO AUTOMATIC TRANSMISSION

(71) Applicant: FORD GLOBAL TECHNOLOGIES, LLC, Dearborn, MI (US)

(72) Inventors: Zhengyu Dai, Canton, MI (US); Hong Jiang, Birmingham, MI (US)

(73) Assignee: FORD GLOBAL TECHNOLOGIES, LLC, Dearborn, MI (US)

(21) Appl. No.: 13/875,799

(22) Filed: May 2, 2013

Related U.S. Application Data
(60) Provisional application No. 61/643,795, filed on May 7, 2012.

(51) Int. Cl. B60W 20/00

(52) U.S. Cl. CPC B60W 20/30; Y10S 903/945
USPC 701/55; 180/65.265; 903/945

(57) ABSTRACT

A hybrid vehicle having an engine and motor in series with a step ratio automatic transmission shifts the transmission according to a first shift schedule based on driver demand and output speed or a second shift schedule based on efficient operating speeds of the engine and motor associated with the target gear ratio. A powertrain controller continually calculates engine and motor speeds and torques associated with target gear ratios for the second shift schedule to select a gear ratio based on operating efficiency. An arbitration strategy may compare a weighted target gear ratio from the first schedule shift schedule to a weighted target gear ratio from the second shift schedule to dynamically select a desired target gear for powertrain control management.

### CROSS-REFERENCE TO RELATED APPLICATIONS

This application claims the benefit of U.S. provisional Application No. 61/643,795 filed May 7, 2012, the disclosure of which is incorporated in its entirety by reference herein.

### TECHNICAL FIELD

The present disclosure relates to shift scheduling in a hybrid vehicle having a step ratio automatic transmission.

### BACKGROUND

Conventional shift scheduling for an automatic transmission is usually controlled as a function of accelerator pedal position (which may be interpreted as a torque demand input) and transmission output shaft speed or the equivalent vehicle speed. The shift schedule may vary by application or vehicle platform to provide desired drivability, performance, and fuel economy. Drivability is a subjective factor associated with driver expectations with respect to vehicle performance relative to any associated noise, vibration, and harshness (NVH) introduced by the vehicle, engine, and drivetrain.

A hybrid vehicle includes an engine and at least one electric machine (operable as a motor or generator) that can be powered directly or indirectly by the engine to drive the vehicle. A traction battery may be provided to store electric energy from the engine when the electric machine operates as a generator, and may be used to drive the vehicle when the electric machine operates as a motor. Use of a motor in combination with an engine provides additional flexibility in determining whether to use the engine, the motor, or both to drive the vehicle to obtain desired performance and fuel economy. For example, the engine may be shut down under certain operating conditions, or used only to charge the battery with the electric motor providing the torque demanded by the driver to move the vehicle. Similarly, for more demanding conditions, the engine may be started and used in combination with the electric motor to deliver maximum torque to the wheels to provide increased performance.

A step ratio transmission includes a finite number of selectable gear ratios. When used in a hybrid vehicle, the selected gear ratio may affect the engine speed and/or motor speed and may also have an impact on drivability, performance, and fuel economy. Compared to a conventional vehicle with only an engine, the shift schedule for a hybrid vehicle may be modified so that the engine and/or electric machine are operated at speeds that are within more efficient operating regions because the operating speed of each power source is not necessarily directly coupled to the vehicle speed. While hybrid vehicles are generally designed to provide higher efficiency than conventional powertrains, it may be desirable for some applications and/or some operating conditions to compromise efficiency for performance and/or drivability. Vehicles having an automatic transmission with a torque converter provide further challenges in determining an appropriate gear for best efficiency and fuel economy.

Vehicle manufactures often attempt to leverage economies of scale by using the same or similar components across multiple vehicle applications. Use of common components, including software and related control strategies, provides more efficient utilization of engineering and development resources and may reduce time-to-market for new or redesigned vehicles.

### SUMMARY

The present disclosure provides various embodiments of a system and method for a hybrid vehicle that incorporate dynamic shift scheduling to select an appropriate gear or gear ratio for an automatic step ratio transmission that provides desired performance, drivability, fuel economy, and/or efficiency for a particular application and/or operating condition. In a hybrid vehicle, the shift schedule is part of the overall vehicle energy management strategy. The strategy may consider engine operating speed and torque regions as well as the electric motor operating speed and torque regions for fuel economy optimization when selecting a target gear. A modified shift schedule based on engine and motor operating efficiency may be selectively applied in place of a standard shift schedule based on driver demand and output speed by weighting target gear ratios from each shift schedule and applying an arbitration strategy to select a desired target gear ratio for a particular application or operating condition. The output speed based shift schedule may be used in engine only operating conditions or in applications where the electric motor is unavailable.

In one embodiment, a hybrid vehicle includes an engine, an electric machine coupled by a disconnect clutch to the engine, a traction battery coupled to the electric machine, an automatic transmission coupled to the electric machine by a torque converter, and a controller configured to shift the automatic transmission according to a first shift schedule based on drivability and a second shift schedule based on efficient operating speeds of the engine and electric machine. The controller may be configured to shift the automatic transmission according to the first shift schedule when the electric machine is unavailable. In various embodiments, the controller is configured to select a target gear ratio from the first shift schedule based on driver demand and transmission output speed and to select a target gear ratio according to the second shift schedule based on efficient engine operating speed and torque and efficient electrical machine operating speed and torque associated with the target gear ratio. In some embodiments, the controller is configured to weight available gear ratios for the first shift schedule and the second shift schedule and to select a target gear ratio based on weighted gear ratios from the first shift schedule and the second shift schedule.

Embodiments according to the present disclosure may provide various advantages. For example, various embodiments add a second shift schedule based on efficient operation of the engine and motor with a weighting strategy to integrate the second shift schedule into a more conventional first shift schedule based on driver demand and output speed and calibrated primarily to provide desired drivability. Use of a weighting factor applied to target gear ratios from a first and second shift schedule and an associated arbitration strategy to select an available gear ratio allows use of the output speed based shift schedule for particular applications or operating conditions, such as applications that do not have an electric motor, or operating conditions where the electric motor is unavailable.

The above advantages and other advantages and features associated with one or more embodiments of the present disclosure may be recognized by those of ordinary skill in the art based on the following detailed description of representative embodiments.

### BRIEF DESCRIPTION OF THE DRAWINGS

The present disclosure may be more clearly understood by reference to the following detailed description, when read in conjunction with the accompanying drawing figures, in which like reference characters refer to like parts throughout the views, and in which:

FIG. 1 is a diagrammatic view of a hybrid vehicle with an automatic step ratio transmission and a powertrain controller configured to select a desired gear ratio based on first and second shift schedules according to embodiments of the present disclosure; and

FIGS. 2A and 2B are a flow chart illustrating operation of a system or method for dynamic shift scheduling according to a representative embodiment of the present disclosure.

### DETAILED DESCRIPTION

As required, detailed embodiments of the invention are disclosed herein; however, it is to be understood that the disclosed embodiments are merely exemplary and may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the disclosure.

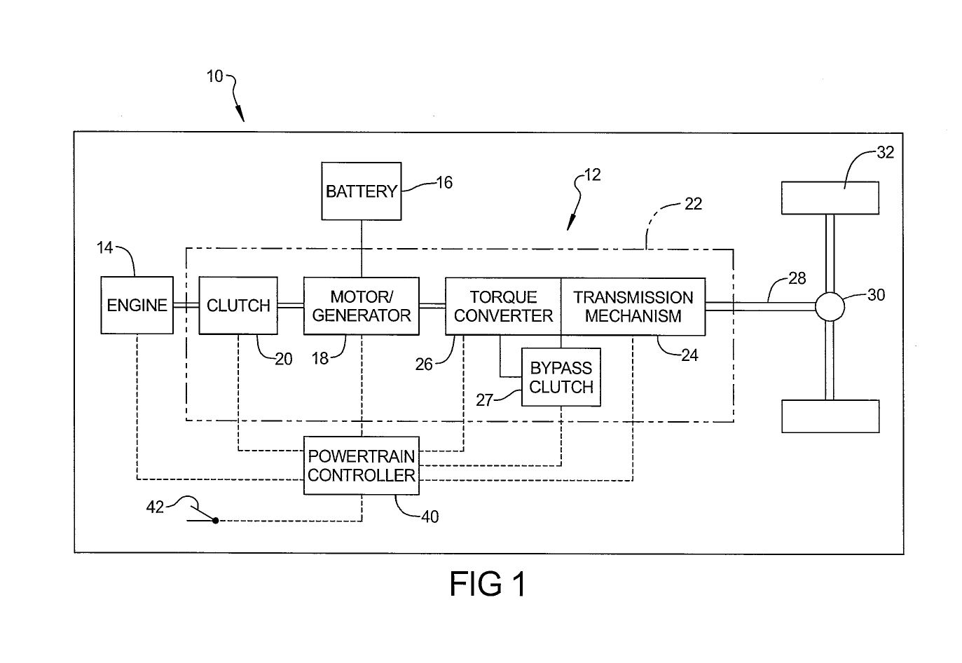

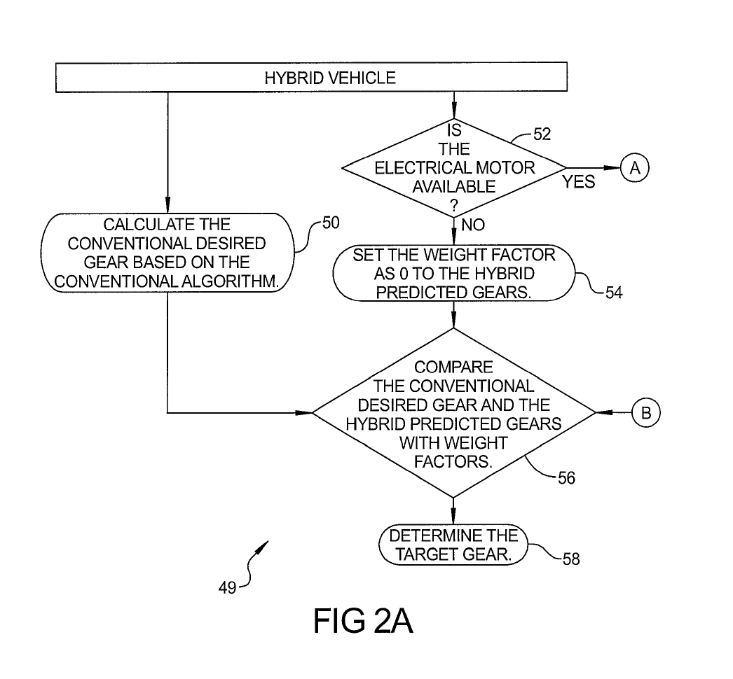

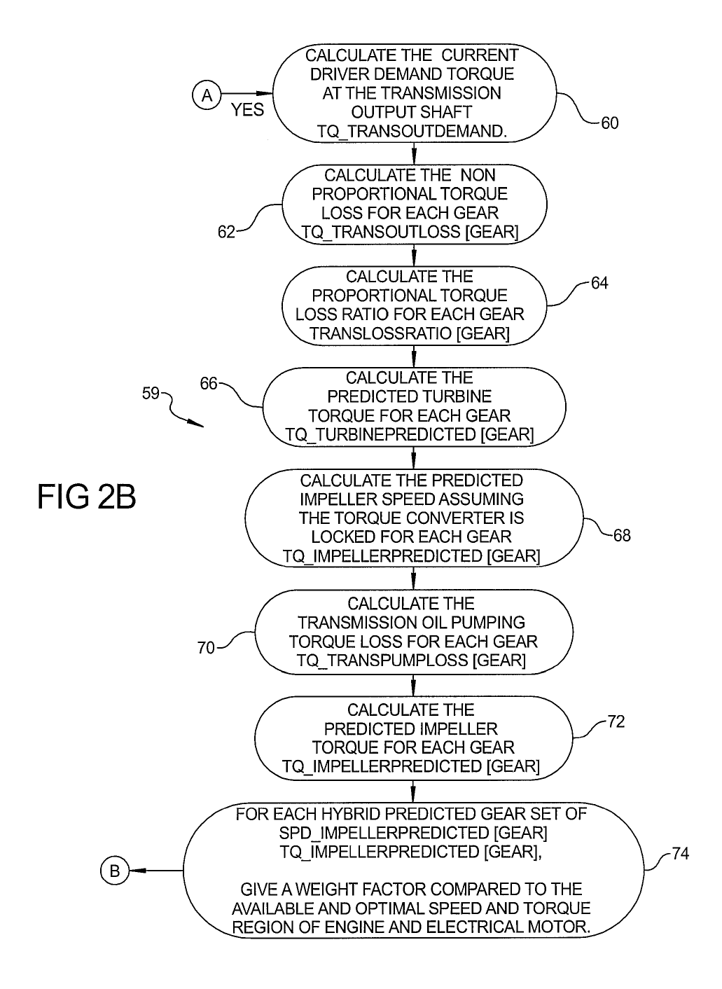

Referring first to FIG. 1, a vehicle 10 is shown comprising a hybrid driveline 12 with a first power source in the form of internal combustion engine 14 and a second power source in the form of a battery 16 that powers an electric machine 18, which may operate as a motor or a generator. Engine 14 may be selectively coupled and decoupled from the remainder of the driveline by corresponding operation of a disconnect clutch 20. The disconnect clutch 20 may be used to couple the engine to the input shaft of the motor 18 so that operation of the engine 14 serves to charge the battery 16 as the electric machine 18 acts as a generator. Similarly, engine 14 may also provide driving torque to the vehicle wheels through disconnect clutch 20 and electric machine 18 when electric machine 18 is operating as a traction motor.

The disconnect clutch 20 disconnects the electric machine 18 from the engine 14 in the electric drive mode whereby only the electric machine 18 is available to power the driveline. In the hybrid drive mode, the disconnect clutch 20 couples the engine 14 with the motor 18 when a command is generated from the powertrain controller 40 to charge the battery based on a battery state of charge (SOC), or to provide additional driving torque as previously described. An accelerator pedal or similar actuator 42 may be used to provide an indication of driver demand, which may be interpreted as a driveline output torque or wheel torque, for example.

The engine 14 is selectively coupled to the input shaft of the electric machine 18, which has an output shaft coupled to an automatic step ratio transmission gearbox or mechanism 24 through the torque converter 26. In one embodiment, automatic step ratio transmission 22 (sometimes referred to as a modular hybrid transmission or MHT) may include mechanical, electromechanical, and hydraulic controls to select one of a finite number of available gears or gear ratios to provide multiple forward speeds, at least one reverse speed and a neutral position. As previously described, automatic transmission 22 may include a torque converter 26 having an impeller and a turbine that rotates in response to fluid flow from the impeller to the turbine. A bypass clutch 27 provides frictional and/or mechanical coupling between the impeller and turbine of the torque converter 26 and is controlled by the powertrain controller 40. A transmission output shaft 28 is linked to a differential 30 and in turn drives both of the rear wheels 32.

As generally understood by those of ordinary skill in the art, the bypass clutch 27 may be operated by managing fluid pressure between the impeller and turbine of the torque converter to provide three modes of bypass clutch operation including open, locked, and slipping. Torque multiplication may occur depending on the amount of slip between the impeller and turbine sides. In open mode, a maximum amount of fluid is carried by the torque converter housing, separating the impeller from the turbine and allowing a greater speed differential between the impeller and turbine to increase torque multiplication. In a locked mode, a lower fluid pressure in the torque converter allows the impeller and the turbine to become frictionally or mechanically locked together to eliminate slip and associated losses to improve efficiency. In a slip mode, a target amount of slip may be employed between the impeller and the turbine to provide a target torque ratio for the multiplication between the turbine and the impeller while also providing driveline damping to reduce propagation of noise, vibration, and harshness (NVH), but efficiency is reduced due to the heat and other losses associated with slipping.

In one embodiment, step ratio automatic transmission gearbox or mechanism 24 is coupled to the output shaft of electric machine 18 by a disconnect clutch similar to disconnect clutch 20 and no torque converter is used. Those of ordinary skill in the art will recognize that similar efficiency calculations as described below with respect to the torque converter may be used in applications having a disconnect clutch, sometimes referred to as a launch clutch, rather than a torque converter.

In accordance with the control system of one embodiment of the present invention, a powertrain controller 40 can include a distributed or integrated set of operating systems including an engine control module (ECM), a transmission control module (TCM) and a vehicle systems controller (VSC), for example. In the embodiment illustrated, an input demand actuator 42, such as an accelerator pedal, is linked either electronically, mechanically or by other systems to the powertrain controller 40. The actuator 42 permits the driver to request a corresponding powertrain power from the vehicle, which may be interpreted by the controller as a driver or drive demand in the form of output torque or power, for example. Depending on the particular operating mode, such as electric only, engine only, or combined drive mode, controller 40 determines an associated engine operating speed and torque, electric machine operating speed and torque, and a desired target gear ratio. The availability of multiple power sources allows controller 40 to select a desired target gear based on output speed (or equivalently vehicle speed) and drive demand, or based on engine speed and electric machine speed to maintain operation of the engine and electric machine within more efficient operating regions to improve overall energy efficiency, thus improve the fuel economy

The powertrain controller 40 may continually calculate the engine and motor speeds and associated efficiencies based on various losses and operating characteristics for available gears or gear ratios to schedule or select a desired target gear ratio. When both power sources are available, the gear ratio selection is determined as a function of the drive demand torque, the engine operating speed and torque region and the motor operating speed and torque region. Processing of the algorithm includes identification of each available gear selection that may be employed under existing operating conditions, and may include selecting the desired target or scheduled gear ratio based on the energy efficiency. Alternatively, shift scheduling may be determined in a more conventional manner based on driver demand and current vehicle or output speed. These shift scheduling strategies may be combined according to embodiments of the present disclosure by weighting the target gear ratios determined based on efficiency and those determined based only on output speed with an arbitration strategy used to select the desired or target gear ratio. The weighting and arbitration strategies may vary depending on the particular application and/or operating conditions to balance drivability, performance, and efficiency.

The operating efficiency associated with each gear ratio may determine an associated weighting factor. The efficiency may be determined by calculating the associated engine and motor operating speeds and torques and considering the associated losses assuming a locked torque converter bypass clutch (or launch clutch). The operating speeds and torques of the engine and electric machine have associated efficiencies that may be stored in the powertrain controller in a lookup table, for example. The weighted gear selections are introduced to an arbitrator or arbitration strategy that may compare the weighted gear ratios based on efficiency to available weighted (or unweighted) gear ratios of a shift schedule based on accelerator pedal position and a drivetrain output speed, for example, which may be sensed at the transmission or at the wheels.

The weighting strategy may vary by application and/or operating conditions. For example, the weighting strategy may vary by application so that vehicles that are more performance oriented weight the efficiency shift schedule lower than applications that are more efficiency oriented. Similarly, common software and calibrations may be utilized by weighting the efficiency shift schedule as “zero” so that only the shift schedule based on driver demand and output speed is used in applications that do not have a traction motor. Similarly, current operating conditions may be used to dynamically adjust the weighting factors. For example, if the traction motor is currently unavailable to provide driving torque due to the battery state of charge or another operating condition, the efficiency based shift schedule may be made unavailable by setting the corresponding weighting factors to very small or zero values to assure that the arbitration strategy selects gear ratios from the schedule based on accelerator pedal input and output speed. Operator selection of a particular driving mode may also be used to dynamically adjust weighting factors and/or influence arbitration between a conventional shift schedule based on drive demand and output speed, and a second shift schedule based on associated efficient operating speeds and/or torques for the engine and/or electric machine. Various other operating conditions or parameters may be used to apply a weighting factor to each available gear ratio.

As previously described, weighting factors may be associated with particular gear ratios based on the corresponding efficiency of the engine and electric machine operating speeds and torques, and associated with the particular gear ratio for the current output speed to meet driver demand. The efficiencies may be determined based on operating regions and characteristics of the engine and electrical machine as well as the losses associated with operating the transmission gearbox and/or torque converter at those operating speeds and torques. In one embodiment, operating efficiencies associated with particular gear ratios may be determined according to the following equations. Those of ordinary skill in the art may recognize various alternative calculations or table look-ups for determining the operating efficiency associated with a particular gear ratio.

The transmission output torque demand 60 (for example, at the transmission output shaft) may be calculated based on the drive demand or driver demanded torque based on the current gear ratio or gear, the acceleration pedal position, and the output speed, as represented by the following equation:

Tq_TransOutDemand=f DriveDemandTq(Gear, AccelPedal, Spd_Output) (1.)

where the output speed Spd_Output is, for example, either the transmission output speed or the equivalent vehicle speed. The transmission output torque demand may be stored in a computer readable storage device associated with the powertrain controller. In one embodiment, transmission output torque demand is stored in a lookup table indexed by gear (or gear ratio), accelerator pedal position, and output speed.

Losses associated with operation of the automatic transmission may include a proportional loss that varies based on the rotational speed or torque of the transmission components and a non-proportional loss that is generally independent of the rotational speed or torque but varies based on other operating conditions, such as transmission oil temperature, for example. The non-proportional transmission torque loss 62 may be calculated using the following equation:

Tq_TransOutLoss=f TransOutLoss(Gear, TransOilTemp, Spd_TransOutput) 2.)

where Tq_TransOutLoss is a transmission operation torque loss not related to the input torque and is based on the target gear, current transmission oil temperature, and transmission output speed. The non-proportional transmission torque loss may be calculated or stored in a look-up table accessed by the powertrain controller and indexed by gear, transmission oil temperature, and transmission output speed.

The Input-Torque-Proportional transmission torque loss ratio 64 varies with the transmission oil temperature and may be calculated or determined according to the following equation:

TransLossRatio=f TransLossRatio(Gear, TransOilTemp) 3.)

where TransLossRatio effectively reduces the gear torque ratio. Therefore the transmission operating loss in terms of torque is directly related to the input torque into the transmission. The transmission loss ratio may be calculated or stored in a lookup table accessed by the powertrain controller based on gear and transmission oil temperature.

The predicted turbine torque 66 may be calculated or determined based on the previously described operating parameters according to the following equation:

$$Tq\_Turbinepredicted = \frac{( Tq\_TransOutDemand + Tq\_TransOutLoss )}{GearRatio ( Gear ) - TransLossRatio} \qquad 4. )$$

The predicted impeller speed (Spd_ImpellerPredicted) 68 may be calculated by assuming the torque converter bypass clutch is locked so that predicted impeller speed may be calculated based on the current gear ratio, and the current transmission output speed, according to the following:

Spd_ImpellerPredicted=Spd_TransOutput*GearRatio(Gear) 5.)

where Spd_TransOutput is the current transmission output speed and GearRatio is the gear ratio associated with the potential target gear. The gear ratio may be stored in a lookup table accessed by the powertrain controller indexed by the gear number.

The transmission pumping torque loss 70 may be calculated or determined based on the transmission oil line pressure, the predicted impeller speed and the transmission oil temperature, according to the following:

Tq_TransPumpLoss=f TransPumpLoss(LinePressure, Spd_ImpellerPredicted, TransOilTemp) 6.)

The transmission pumping loss may be stored in a lookup table accessed by the powertrain controller where the table is indexed or based on the line pressure, predicted impeller speed, and transmission oil temperature.

The predicted impeller torque 72 assuming the locked torque converter bypass clutch may be calculated according to the following:

Tq_ImpellerPredicted=Tq_TurbinePredicted+Tq_TransPumpLoss 7.)

Based on the drive torque demand and other system conditions, the powertrain controller calculates and/or determines from one or more lookup tables the predicted impeller speed and torque for each available target gear or gear ratio. A weighting factor is assigned 74 to each available target gear based on the predicted impeller speed and torque for each gear relative to the engine speed and torque operating region and the electric machine speed and torque operating region. The powertrain controller applies an arbitrator or arbitration strategy that compares the weighted gear or gear ratios based on operating efficiency to weighted gear ratios based on a conventionally scheduled desired gear to determine the target gear for the particular application and/or operating conditions.

The engine operating speed and torque region may be mapped with the fuel consumption efficiency factor which shows the relationship between the fuel consumption and the effective engine output. The electric machine speed and torque region may be mapped with the electric motor operating efficiency factor and may vary based on the status or state of charge of the traction battery. A weighting factor 56 may be associated with each of the available sets of the target impeller speed and impeller torque, the predicted engine operating speed and torque, and the predicted motor operating speed and torque, will give an indication of the relative operating efficiency factor for the vehicle and may be used to select a desired or target gear ratio for the step ratio automatic transmission to meet the driver demanded torque and improve the fuel economy through operating at more efficient engine and/or motor speed and torque region.

Comparing the conventional shift schedule gear selection with the dynamic shift schedule gear selection based on the weighting factors, the target or desired gear can be determined 58. The conventional shift schedule gear selection can still be used in applications or operating conditions where the electric machine is unavailable as previously described.

As such, embodiments according to the present disclosure provide a system and method for dynamically controlling a target gear selection in a hybrid vehicle with an internal combustion engine and a step ratio automatic transmission having a torque converter. In one embodiment, the method may include establishing a first shift schedule wherein a first gear is selected as a function of drive demand and output speed under the operating conditions, and establishing a second shift schedule wherein at least one second gear may be selected as a function of engine operating speed and torque region and as a function of motor operating speed and torque region under the operating conditions. The method may also include weighting each first and each at least one second gear selection based on engine and motor efficiency, and then arbitrating the first gear selection with each weighted second gear selection to select the target gear having best efficiency.

In one embodiment, establishing a second shift schedule comprises determining or calculating a predicted impeller speed under operating condition for each of the at least one second gear. Establishing a second shift schedule may comprise calculating a predicted impeller torque under operating conditions associated with each of the at least one second gear. Calculating or determining the predicted impeller torque may comprise compensating for a transmission pumping torque loss under operating conditions for each of the at least one second gear. The calculating or determining may comprise predicting a turbine torque under operating conditions for each of the multiple stepped ratio gears. Predicting the turbine torque may include compensating for a proportional torque loss due to gear ratio for each of the multiple stepped ratio gears. Predicting the turbine torque may include compensating for a non-proportional torque loss for each gear associated with operating conditions such as transmission oil temperature, and transmission output speed for each gear. Predicting the turbine torque may include adjusting for a target drive demand torque at the transmission output shaft. Adjusting for a target drive demand torque may include adjusting for the current gear, the acceleration pedal position, and the output speed. Arbitrating may include comparing the weighting of a target gear from the first shift schedule to each available target gear from the second shift schedule.

In one embodiment, a method of dynamically controlling gear selection of a multiple, stepped gear transmission in a hybrid vehicle with engine and motor sources includes shifting the transmission to a desired gear selected from one of a first shift schedule based on accelerator position and vehicle speed, and a second shift schedule based on engine and motor operating efficiency. The powertrain controller determines the target gear under operating conditions by predicting speed and torque targets for each of the multiple gear ratio selections. A weighting factor for each available gear ratio is then determined. An arbitrator or arbitration strategy selects the desired or target gear based on the weighting factor to provide desired drivability, performance, and efficiency for the particular application or operating conditions.

Various embodiments of the disclosure provide a system for dynamically controlling gear selection in a hybrid vehicle with an internal combustion engine, an electric motor power source and an automatic step ratio transmission having a torque converter. The system may include a powertrain controller with computer interfaced processing of sensor signals of driver demand, output speed, engine speed and torque, and motor speed and motor. The controller may employ a first shift schedule determined as a function of drive demand and output speed and a second shift schedule for energy efficiency by determining engine speed and torque as well as motor speed torque for available gear ratios. The system may include a powertrain controller configured to select a target gear by weighting each available gear in the second shift schedule based on targetoperating regions of the engine and traction motor for improved efficiency.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A method for controlling a target gear selection in a hybrid vehicle with an internal combustion engine, a motor, and a step ratio automatic transmission, and a powertrain controller having a first shift schedule for selecting a first target gear ratio based on drive demand and output speed, the method comprising:
establishing a second shift schedule having second target gear ratios based on efficient operating speeds of the engine and the motor for current output speed and the drive demand;
weighting the first target gear ratio and the second target gear ratios;
arbitrating the weighted first gear ratio and each of the weighted second gear ratios to select a desired target gear ratio; and
shifting the transmission for engagement of the desired target gear ratio.

2. The method of claim 1 wherein shifting the transmission comprises shifting the transmission in response to a predicted torque converter impeller speed associated with operating conditions for the second target gear ratios.

3. The method of claim 1 wherein shifting the transmission comprises shifting the transmission in response to a predicted torque converter impeller torque associated with operating conditions for the second target gear ratios.

4. The method of claim 3 wherein the predicted torque converter impeller torque is based on a torque value to compensate for a transmission pumping torque loss under operating conditions for the second target gear ratios.

5. The method of claim 3 wherein the predicted torque converter impeller torque is based on a predicted torque converter turbine torque associated with operating conditions for the second target gear ratios.

6. The method of claim 5 wherein the predicted turbine torque is based on a torque value that compensates for a proportional torque loss associated with second target gear ratios.

7. The method of claim 5 wherein the predicted turbine torque is based on a torque value that compensates for a non-proportional torque loss relative to the transmission oil temperature, and transmission output speed associated with second target gear ratios.

8. The method of claim 5 wherein the predicted turbine torque is based on providing a transmission output shaft torque associated with the drive demand.

9. The method of claim 8 wherein the transmission output shaft torque demand is based on current gear ratio, accelerator pedal position, and the output speed.

10. The method of claim 1 wherein arbitrating comprises comparing the weighting of the first target gear ratio and the second gear ratios.

11. A hybrid vehicle comprising:
an engine;
an automatic transmission having a torque converter with an impeller and a turbine and selectable step gear ratios;
a traction motor coupled to the impeller and selectively coupled to the engine by a disconnect clutch; and
a powertrain controller configured to control gear selection with respect to a first shift schedule for each of the selectable step gear ratios as a function of drive demand and vehicle output speed, and a second shift schedule for each of the selectable step gear ratios as a function of engine operating speed and torque and motor operating speed and torque.

12. The hybrid vehicle of claim 11 wherein the controller is configured to shift the transmission using the second shift schedule to operate the engine and motor within associated efficient operating regions.

13. The hybrid vehicle of claim 12 wherein the controller is configured to shift the transmission based on a predicted impeller speed associated with operating conditions for each of the selectable step gear ratios.

14. The hybrid vehicle of claim 13 wherein the controller is configured to select the first shift schedule or the second shift schedule based on weighting each gear ratio for efficiency and drivability.

15. The hybrid vehicle of claim 14 wherein the controller is configured to arbitrate gear ratio selection by comparing the weighting of each gear ratio for target operating conditions.

16. A hybrid vehicle, comprising:
an engine;
an electric machine coupled by a disconnect clutch to the engine;
a traction battery coupled to the electric machine;
an automatic transmission coupled to the electric machine by a torque converter; and
a controller configured to shift the automatic transmission according to a first shift schedule based on drivability and a second shift schedule based on efficient operating speeds of the engine and electric machine.

17. The hybrid vehicle of claim 16 wherein the controller is configured to shift the automatic transmission according to the first shift schedule when the electric machine is unavailable.

18. The hybrid vehicle of claim 17 wherein the controller is configured to select a target gear ratio from the first shift schedule based on driver demand and transmission output speed.

19. The hybrid vehicle of claim 16 wherein the controller is configured to select a target gear ratio according to the second shift schedule based on efficient engine operating speed and torque and efficient electrical machine operating speed and torque associated with the target gear ratio.

20. The hybrid vehicle of claim 16 wherein the controller is configured to weight available gear ratios for the first shift schedule and the second shift schedule and to select a target gear ratio based on weighted gear ratios from the first shift schedule and the second shift schedule.
